(19) United States
(12) Patent Application Publication
(10) Pub. No.: US 2010/0089196 A1
(43) Pub. Date: Apr. 15, 2010

(54) VENTILATED BICYCLE HANDLEBAR

(76) Inventor: Massimo Losio, Asolo (Treviso) (IT)

Correspondence Address: TUTUNJIAN + BITETTO, P.C., 20 CROSSWAYS PARK NORTH, SUITE 210, WOODBURY, NY, 11797, US

(21) Appl. No.: 12/520,933

(22) PCT Filed: Dec. 27, 2007
(86) PCT No.: PCT/IB2007/004124

§ 371 Date: Jun. 23, 2009

(30) Foreign Application Priority Data
Dec. 28, 2006 (IT) VI2006A000366

(51) Int. Cl. B62K 21/12; B62K 21/26

(52) U.S. Cl. 74/551.9; 74/551.1

(57) ABSTRACT

The present invention finds application in the art of sport and leisure accessories, and relates to a ventilated bicycle handlebar, which includes a tubular body having an axial inner cavity, a center portion for connection to a bicycle frame and end portions, designed to be grasped by the hands of a user. The tubular body has an air inlet at the center portion and an air outlet in the remaining areas. The inlet is partly or wholly oriented in the riding direction so that the incoming air can flow through the inner cavity and come out of the outlet to ventilate the hands of a user during riding.

### FIELD OF THE INVENTION

The present invention generally finds application in the technical field of sport and leisure accessories, and particularly relates to a tubular bicycle handlebar having holes for ventilating its handgrip portions.

### BACKGROUND OF THE INVENTION

A bicycle handlebar is known to be formed of a tubular or solid bar which is mounted to the bicycle frame at its center portion and is designed to be grasped by the cyclist at its ends.

Furthermore, handgrips or tapes of elastomeric materials, gels, leather or the like, for a safer and more comfortable grip by the cyclist, are usually applied to the gripping areas.

U.S. Pat. No. 4,462,267 and US20030226420 disclose particular embodiments of bicycle handlebars.

Nevertheless, extensive riding, particularly in competitions, or riding in particular high temperature conditions can lead to excessive hand perspiration, which can affect grip stability or even cause damage to the skin, e.g. skin blisters.

In view of the above, cyclists usually wear gloves or use similar protection, which possibly have microholes for improved ventilation. However, these accessories have a relatively high cost and are designed for a specialist market.

Other more common glove types, such as gloves of natural or synthetic fabric have a lower cost but do not ensure a proper gripping and can jeopardize cyclists' safety.

### SUMMARY

The object of this invention is to obviate the above drawbacks, by providing a ventilated bicycle handlebar that is highly efficient and relatively cost-effective.

A particular object is to provide a handlebar that allows ventilation at its handgrip portions to reduce hand perspiration and ensure efficient gripping by the user.

These and other objects, as better explained hereafter, are fulfilled by a ventilated bicycle handlebar, which comprises a tubular body with an inner axial cavity, a central portion for connection to a bicycle frame and end portions designed to be grasped by the hands of a user.

According to the invention, the tubular body has at least one inlet opening at its central portion and at least one outlet opening in the other areas, said at least one inlet being at least partly oriented in the riding direction so that the incoming air flows through the inner cavity and comes out of the outlet opening.

Thanks to this particular configuration, the handlebar in accordance with the invention allows ventilation of the cyclist's hands to eliminate or at least reduce perspiration, thereby ensuring effective gripping by the cyclist.

Advantageously, at least one pair of inlet opening and at least one pair of outlet openings may be provided, which are arranged symmetrically with respect to the centerline of the tubular body.

Thus, the inlet openings may have relatively small sizes, so that the mechanical resistance properties of the handlebar are not excessively reduced, and that the handlebar has a well-balanced and symmetrical behavior during riding.

Also, the handlebar may comprise a pair of substantially tubular handgrips that are fixed to the tubular body at the gripping portions and have a plurality of substantially radial transverse slots for ensuring fluid connection of the outlet openings with the outside.

Otherwise, the handlebar may be equipped with a pair of tapes with microholes wrapped around the tubular body at the gripping portions having outlet openings.

Thus, both configurations will afford maximum gripping comfort for the user at the handgrip portions.

### BRIEF DESCRIPTION OF THE DRAWINGS

Further features and advantages of the invention will be more apparent from the detailed description of a preferred, non-exclusive embodiment of a ventilated bicycle handlebar of the invention, which is described as a non-limiting example with the help of the annexed drawings, in which:

FIG. 1 is a perspective view of a first embodiment of a bicycle handlebar according to the invention;

FIG. 2 is a partly broken away front view of a detail of the handlebar as shown in FIG. 1;

FIG. 3 is a broken away view of a detail of the handlebar of the invention, as taken along the plane I-I of FIG. 2;

FIG. 4 is an exploded top view of the detail of FIG. 2, in a first preferred configuration;

FIG. 5 is a side view of the handlebar of the invention, as taken along the plane II-II of FIG. 2;

FIG. 6 is an exploded top view of the detail of FIG. 2, in a second preferred configuration;

FIG. 7 is a front view of a handlebar of the invention in a third preferred configuration; and

FIG. 8 is a top view of the handlebar of FIG. 7.

### DETAILED DESCRIPTION OF PREFERRED EMBODIMENTS

Referring to the above figures, the handlebar of the invention, generally designated with numeral 1, may be attached to a frame T of a bicycle and generally to any vehicle, even motor vehicles, having one or more front wheels steered by a handlebar.

The handlebar 1 may be formed of metal, plastic or composite material, such as carbon fiber or the like and may be attached to the frame in a permanent or removable manner.

According to the invention, the handlebar 1 has a tubular body 2 having an axial inner cavity 3, a central portion 4 for connection to a bicycle frame T and end portions 5, 5′, designed to be grasped by the hands of a user.

According to a peculiar feature of the invention, the tubular body 2 has at least one air inlet 6 near to its central portion 4 and at least one air outlet opening 7 in the remaining areas.

The inlet opening 6 is at least partly oriented in the vehicle advancement direction so that the incoming air can flow through the inner cavity 3 and come out of the outlet opening 7 to ventilate the hands of a user during advancement.

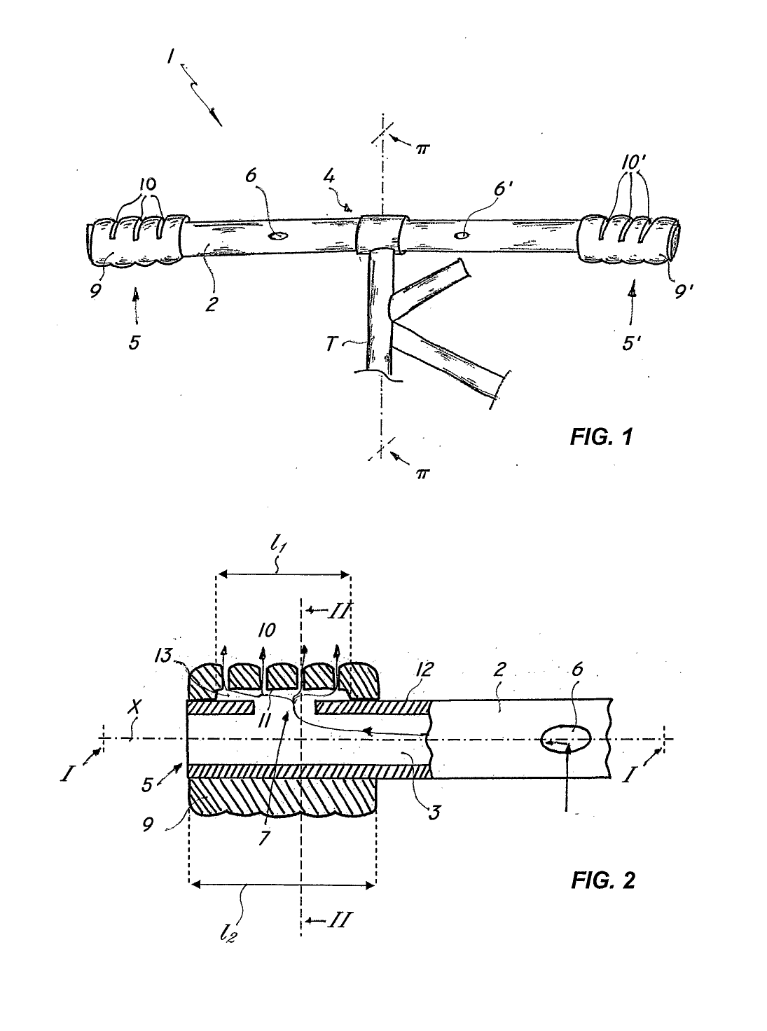

As shown in FIG. 1, the handlebar 1 can have a pair of inlet openings 6, 6′ arranged symmetrically with respect to the center line \textcircled{6} of the tubular body 2 and in fluid connection with a pair of outlet openings 7, as shown in the cross section of FIG. 2, in which arrows indicate the air flow from the inlet opening 6 to the outlet opening 7 through the inner cavity 3.

Thus, the inlet openings 6, 6′ can have relatively small sizes, so that the mechanical resistance of the handlebar 1 remains unaffected and sufficient ventilation is ensured, while a uniform response to motion stresses is achieved.

In a preferred, non exclusive configuration of the invention, as shown in the figures, the outlet openings 7 may be formed at respective end portions 5, 5′ of the tubular body 2.

Nevertheless, it shall be understood that other configurations may be provided, e.g., including one or more pairs of such outlet openings 7, not necessarily arranged in symmetric, intermediate positions between the center line \textcircled{6} of the tubular body 2 and its end portions 5, 5′.

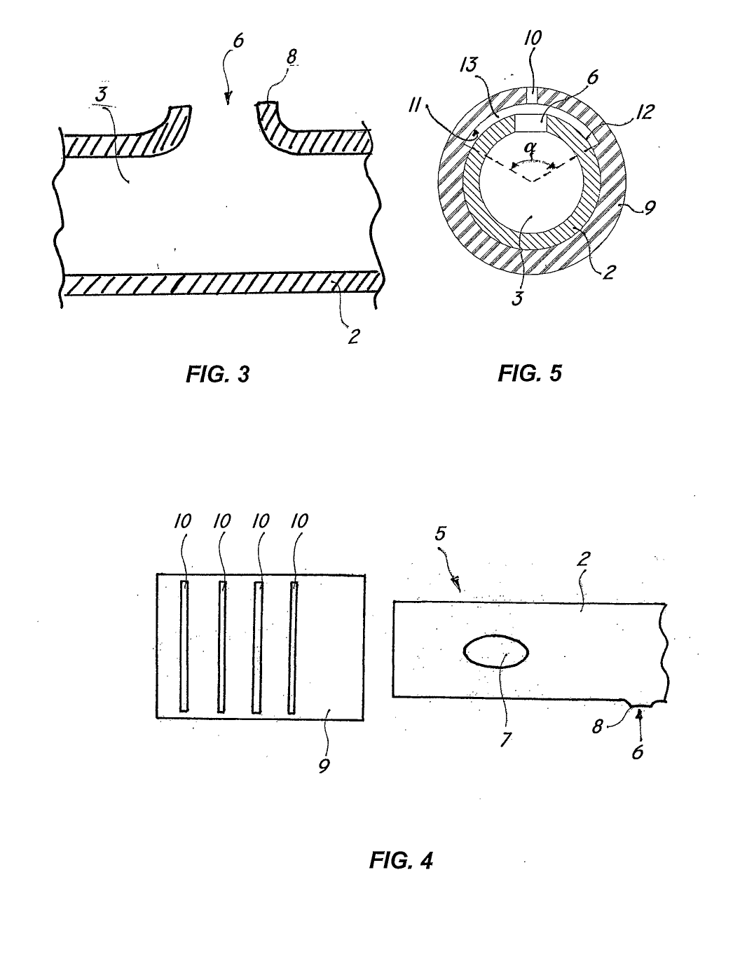

In FIG. 3, the inlet openings 6, 6′ are shown to have a projecting and diverging peripheral edge 8, to increase the incoming air flow while reinforcing the structure of the handlebar 1 in the area in which they are formed.

In the configuration of FIG. 3, the peripheral edge 8 projects outwards, although it can also project inwards, and obtain substantially the same effects as in the previous case.

For a more comfortable gripping effect, each of the end portions 5, 5′ of the tubular body 2 can be equipped with a substantially tubular handgrip 9, 9′ having a plurality of substantially radial transverse slots, generally designated by numerals 10 and 10′ respectively, for fluid connection of the corresponding outlet 7 with the outside, and for even distribution of the outflowing air over the hands.

Reference will be made hereinafter to one handgrip of the pair and its respective end portion 5, but all the parts therein shall be understood to be present in a substantially similar manner on the other.

In a preferred, non exclusive configuration of the invention as shown in FIG. 4, the radial transverse slots 10 may be axially spaced and define respective arcs of circles having a predetermined angular extension.

In the sectional view of FIG. 2, the handgrip 9 is also shown to have, at least partly in front of its respective air outlet opening 7, an inner cylindrical surface 11 radially spaced from the outer cylindrical surface 12 of the end portion 5, thereby defining an air space 13 in fluid communication both with the radial transverse slots 10 and the outlet opening 7.

The air space 13 can have a shorter longitudinal extension l₁ than the overall length l₂ of the corresponding handgrip 9 and a predetermined angular extension α substantially coinciding with the angular extension of its respective radial slots 10.

FIG. 5 shows that the air space 13 may have an angular extension α of about 180°, thereby covering a wide portion of the cyclist's gripping area. However, the air spaces 13 may have angular extensions a above or below such value, without departure from the scope of the present invention.

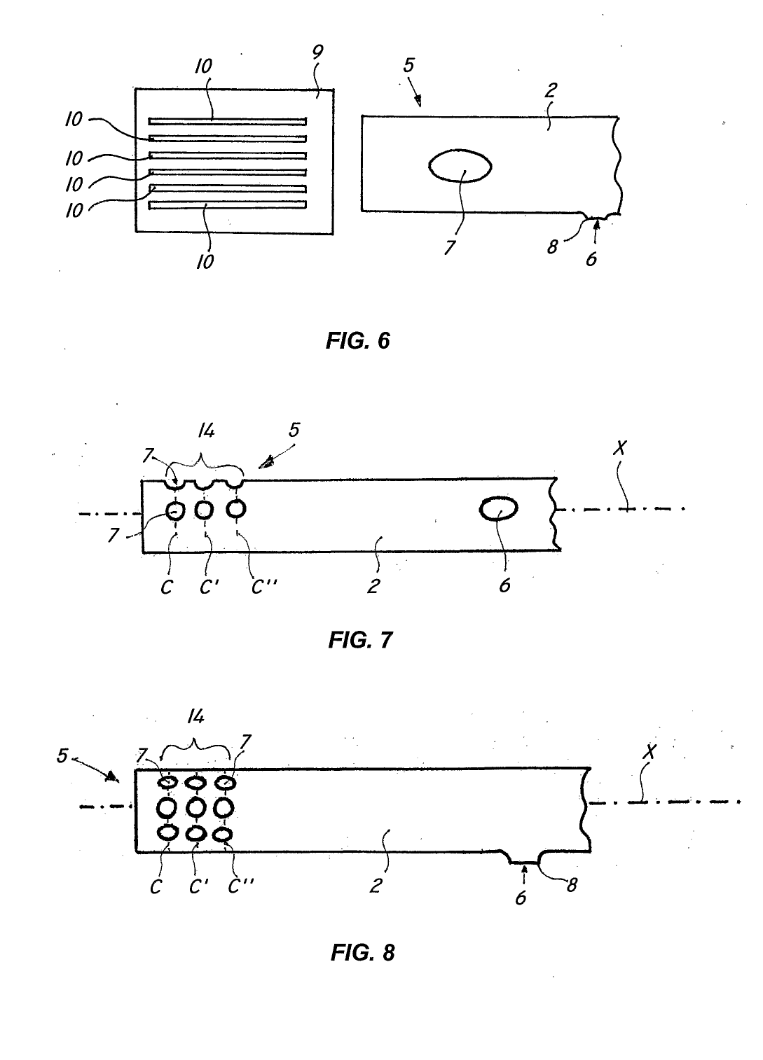

FIG. 6 shows an alternative embodiment of the handgrip 9 in which the radial slots 10 may have a substantially axial and parallel orientation and cover substantially the whole angular extension α of its respective air space 13.

According to another embodiment, not shown, a pair of tapes with microholes may be provided instead of the handgrips 9, 9′, and be wrapped around the gripping portions 5, 5′ with the outlets 7, to provide substantially the same user hand ventilation effect during riding.

A further configuration for the ventilated handlebar 1 of the invention is shown in FIGS. 7 and 8. In this case, the handlebar 2 may have two series of outlet openings 7, one of which is only shown and generally designated by numeral 14, which are arranged along respective end portions 5, 5′ of the tubular body 2.

The outlet openings 7 of each series 14 may be arranged along circular arcs C, C′, C″ substantially transverse to the axis X of the tubular body 2 in longitudinally staggered positions.

Also, each circular arc C, C′, C″ can have a predetermined angular extension in a range from 60° to 270°, and preferably of 180°, having a bisecting line directed towards the user gripping area.

In this embodiment, the handlebar 1 can be equipped or not with the handgrips 9, 9′ or the tapes with microholes at its end portions 5, 5′. If handgrips 9, 9′ are provided, their respective series of radial slots 10, 10′ may face towards respective circular arcs C, C′, C″ defined by the outlets 7 and their angular extension may substantially coincide with the angular extension of the corresponding circular arcs C, C′ C″.

It shall be understood that each series 14 of outlet openings 7 may be composed of any number of outlet openings 7, and that the radial slots 10, 10′ may be also provided in different numbers and arrangements on the handgrips 9, 9′ from those of the Figures, which are only proposed by way of illustration and without limitation.

The above disclosure clearly shows that the invention fulfils the intended objects, and particularly meets the requirement of providing a handlebar that allows ventilation at its handgrip portions to reduce hand perspiration and ensure efficient gripping by the user.

The handlebar of the invention is susceptible of a number of changes and variants, within the inventive concept disclosed in the appended claims. All the details thereof may be replaced by other technically equivalent parts, and the materials may vary depending on different needs, without departure from the scope of the invention.

While the handlebar has been described with particular reference to the accompanying figures, the numerals referred to in the disclosure and claims are only used for the sake of a better intelligibility of the invention and shall not be intended to limit the claimed scope in any manner.

1. A ventilated handlebar comprising a tubular body having an axial inner cavity, a central portion for connection to a connecting frame and end portions designed to be grasped by hands of a user, wherein said tubular body has at least one air inlet opening near to said central portion and at least one air outlet opening in remaining areas, said at least one inlet opening being at least partly oriented in an advancement direction so that incoming air can flow through said inner cavity and come out of said at least one outlet to ventilate the hands of a user during advancement.

2. Handlebar as claimed in claim 1, wherein the handlebar has at least one pair of inlet openings and at least one pair of outlet openings, which are arranged symmetrically with respect to the centerline of said tubular body.

3. Handlebar as claimed in claim 1, wherein said outlet openings are arranged at respective end portions of said tubular body.

4. Handlebar as claimed in claim 1, wherein the handlebar comprises a pair of substantially tubular handgrips that are fixed to said tubular body at said end portions, said handgrips having a plurality of substantially radial transverse slots for ensuring fluid connection of said outlets with the outside.

5. Handlebar as claimed in claim 4, wherein said radial transverse slots are axially spaced and define respective circular arcs having a predetermined angular extension.

6. Handlebar as claimed in claim 4, wherein said substantially tubular handgrips have, in front of said outlets, an inner cylindrical surface radially spaced from the outer cylindrical surface of said end portions, thereby defining respective air spaces in fluid communication both with said radial transverse slots and with said outlets.

7. Handlebar as claimed in claim 1, wherein said air spaces (13) have a predetermined angular extension substantially coinciding with the angular extension of said radial slots.

8. Handlebar as claimed in claim 1, wherein the handlebar has a pair of tapes with microholes wrapped around said tubular body at respective gripping portions having said air outlet openings.

9. Handlebar as claimed in claim 1, wherein the handlebar has two series of said outlet openings arranged over respective end portions of said tubular body.

10. Handlebar as claimed in claim 9, wherein the outlet openings of said series are arranged along circular arcs substantially transverse to the axis of said tubular body in longitudinally staggered positions.

11. Handlebar as claimed in claim 10, wherein said circular arcs have a predetermined angular extension with a bisecting line centered on the user gripping area.

12. Handlebar as claimed in claim 11, wherein said angular extension is of 60° to 270°.

13. Handlebar as claimed in claim 11, wherein said angular extension is about 180°.
